(19) United States
(12) Patent Application Publication
(10) Pub. No.: US 2026/0070802 A1
(43) Pub. Date: Mar. 12, 2026

(54) NUCLEATING AGENT FOR POLYLACTIC ACID FORMULATION

(71) Applicant: OMYA INTERNATIONAL AG, Oftringen (CH)

(72) Inventors: Wenbing XIE, Singapore (SG); Matthias WELKER, Hésingue (FR); KienMun TANG, Singapore (SG); Joris BARANGER, Kembs (FR)

(73) Assignee: OMYA INTERNATIONAL AG, Oftringen (CH)

(21) Appl. No.: 19/105,799

(22) PCT Filed: Aug. 31, 2023
(86) PCT No.: PCT/EP2023/073948

§ 371 Date: Feb. 22, 2025

(30) Foreign Application Priority Data
Sep. 2, 2022 (EP) 22193746.9

(51) Int. Cl. C01F 11/18; C08K 3/26; C08K 9/04

(52) U.S. Cl. CPC C01F 11/18; C08K 3/26; C08K 9/04; C01P 2004/51; C01P 2004/61; C01P 2004/62; C01P 2006/12; C08K 2003/265; C08K 2201/003; C08K 2201/006

(57) ABSTRACT

The invention relates to a composition comprising ground natural calcium carbonate being surface treated with phenylphosphonic acid and/or one or more salt(s) thereof, a process for manufacturing the same, its use as a nucleating agent in the production of a polymer formulation, a method for producing the polymer formulation, a nucleating agent comprising the composition, as well as a polymer formulation comprising the composition, and its use.

The invention relates to compositions comprising calcium carbonate being surface treated with phenylphosphonic acid and/or one or more salt(s) thereof, a process for manufacturing the same, their use as a nucleating agent in the production of polymer formulations, especially polylactic acid formulations, a method for producing the polymer formulations, a nucleating agent comprising the composition, as well as a polymer formulation comprising the composition, and the application fields thereof.

In the field of polymer production, talc is usually used as nucleating agent for many polymers such as polyesters, especially polylactic acid (PLA) as well as for other semi-crystalline polymers.

Talc, however, is very limited as regards its natural resources and also is associated with some hazardous substances such as asbestos.

Furthermore, zinc salts of phenylphosphonic acid are known as nucleating agents. Zinc salts of phenylphosphonic acid (ZnPPA) are effective and efficient nucleating agent. However, they are usually added in the polymer manufacturing step, which is a challenge in view of the homogenous distribution of the ZnPPA powder in the polymer either in the polymerization step or during the compounding step. Furthermore, ZnPPA must be ground very finely to be efficient.

Also, nano-sized precipitated calcium carbonate supported phenylphosphonic acid nucleating agents are known, which, however, are prepared in acetone in order to avoid a too high moisture content being detrimental to the crystallization properties of the polymer. Acetone, however, is very hazardous for large-scale industrial production and very costly.

Generally, it has been found that precipitated calcium carbonate (PCC) tends to contain and introduce moisture into the polymer mixture, which however has a negative influence in most polyester (e.g. PET, PHA or PLA) such that processing would be deteriorated. Thus, polymer mixtures comprising water cannot easily be used to produce a good quality product.

Therefore, there is an ongoing need for nucleating agents, being effective, especially in semi-crystalline polymer compositions, which are easily produced using readily available non-hazardous educts, which increase the crystallinity of the polymer, the production throughput to achieve the same degree of crystallinity, which improve the mechanical properties and, thus, reduce the required polymer amount.

One or more of the foregoing and other objects are solved by the subject-matter as defined in the independent claims. Advantageous embodiments of the present invention are defined in the corresponding subclaims.

It should be understood that, for the purpose of the present invention, the following terms have the following meaning:

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined hereinabove. The phrases “comprising”, “containing”, “having” and “including” mean “having at least the following elements . . . ” and are therefore meant to be open (inclusive) and do not exclude additional limitations.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Thus, according to one aspect of the present invention, a composition comprising calcium carbonate being surface treated with phenylphosphonic acid and/or one or more salt(s) thereof is provided, wherein
the calcium carbonate is a ground natural calcium carbonate (GNCC), and wherein
the ground natural calcium carbonate (GNCC) is at least partially coated with the phenylphosphonic acid and/or one or more salt(s) thereof.

The term “ground natural calcium carbonate” (GNCC) as used herein refers to a particulate material obtained from geological sources such as natural calcium carbonate-containing minerals, such as chalk, limestone, marble or dolomite, or from biological sources, such as eggshells, oyster shells or seashells, which has been processed in a wet and/or dry comminution step, such as crushing and/or grinding, and optionally has been subjected to further steps such as screening and/or fractionation, for example, by a cyclone or a classifier.

However, it is to be noted ground natural calcium carbonate obtained from geological sources and being surface treated with phenylphosphonic acid provides better nucleating properties in polymer formulations than ground natural calcium carbonate (GNCC) obtained from biological sources and being surface treated with phenylphosphonic acid.

In view of this, ground natural calcium carbonate (GNCC) obtained from geological sources such as chalk, limestone, marble or dolomite is preferred over ground natural calcium carbonate (GNCC) obtained from biological sources, such as eggshells, oyster shells or seashells.

Thus, the ground natural calcium carbonate (GNCC) is preferably selected from the group comprising, more preferably consisting of, marble, chalk, limestone, dolomite, and mixtures thereof. More preferably, the ground natural calcium carbonate (GNCC) is selected from the group comprising, more preferably consisting of, marble, chalk, limestone and mixtures thereof. Most preferably, the ground natural calcium carbonate (GNCC) is selected from the group comprising, more preferably consisting of, marble, chalk and mixtures thereof. For example, the ground natural calcium carbonate (GNCC) is marble.

Furthermore, ground natural calcium carbonate (GNCC) obtained from biological sources, such as eggshells, oyster shells or seashells is preferably excluded from the present invention.

Ground natural calcium carbonate has the advantage that it may be provided with a very low moisture content, and contrary to precipitated calcium carbonate may be more easily dried. Thus, it is to be noted that a ground natural calcium carbonate (GNCC) is to be differentiated from a precipitated calcium carbonate. Accordingly, ground natural calcium carbonate is clearly superior to precipitated calcium carbonate (PCC), which, therefore, is excluded from the present invention.

The ground natural calcium carbonate (GNCC) may have a weight median particle diameter d₅₀ (wt) of from 0.2 to 20 μm, preferably from 0.6 to 10 μm, more preferably from 1 to 6 μm, and most preferably from 1.3 to 4 μm.

According to a further preferred embodiment of the present invention, the ground natural calcium carbonate (GNCC) particles have a top cut particle diameter d₉₈ (wt) of not more than 80 μm, preferably not more than 50 μm, even more preferably not more than 30 μm, most preferably not more than 15 μm, and especially have a top cut particle diameter d₉₈ (wt) of from 8 to 12 μm, e.g. from 9 to 10 μm.

The value dₓ represents the diameter relative to which x % of the particles have diameters less than dₓ. This means that the dos value is the particle size at which 98% of all particles are smaller. The d₉₈ value is also designated as “top cut”. The dₓ values may be given in volume or weight percent. The d₅₀ (wt) value is thus the weight median particle size, i.e. 50 wt % of all particles are smaller than this particle size, and the d₅₀ (vol) value is the volume median particle size, i.e. 50 vol % of all particles are smaller than this particle size.

In a further preferred embodiment, the ground natural calcium carbonate (GNCC) has a BET specific surface area of from 0.1 to 100 m²/g, preferably of from 1 to 50 m²/g, more preferably 2 to 30 m²/g, even more preferably of from 2.5 to 20 m²/g, most preferably of from 3.5 to 10 m²/g, e.g. of from 3 to 4 m²/g.

Furthermore, it is preferred that the ground natural calcium carbonate (GNCC) has a residual total moisture content of ≤0.5 wt %, preferably ≤0.3 wt %, even more preferably ≤0.2 wt %, and most preferably ≤0.15 wt %, e.g. from 0.02 to 0.1 wt %, based on the total dry weight of the natural ground calcium carbonate.

The “total moisture content” of a material may be measured according to the Karl Fischer coulometric titration method determining the percentage of moisture (e.g. water), which may be desorbed from a sample upon heating to 220° C.

The surface treatment according to the present invention means that the phenylphosphonic acid and/or one or more salt(s) thereof is associated with the surface of the ground natural calcium carbonate (GNCC). This may include an association by physical mechanisms such as electrostatic attraction, and/or by chemical mechanisms, such as a chemical reaction of the phenylphosphonic acid and/or one or more salt(s) thereof with the surface of the ground natural calcium carbonate (GNCC).

The ground natural calcium carbonate (GNCC) is at least partially coated with phenylphosphonic acid and/or one or more salt(s) thereof.

In a preferred embodiment, the ground natural calcium carbonate (GNCC) is at least partially coated with phenylphosphonic acid.

In another preferred embodiment, the ground natural calcium carbonate (GNCC) is at least partially coated with one or more salt(s) of phenylphosphonic acid, which may be selected from the group comprising alkali salts, such as lithium, sodium, potassium salts; alkaline earth salts, such as calcium, magnesium, barium salts; transition metal salts, such as zinc salts, and mixtures thereof, wherein the calcium salt of phenylphosphonic acid is especially preferred.

If a phenylphosphonic acid calcium salt is used, it may be prepared before the surface treatment of the ground natural calcium carbonate (GNCC) and/or may be formed in situ during the surface treatment with phenylphosphonic acid.

In a still further preferred embodiment, the ground natural calcium carbonate (GNCC) is at least partially coated with a mixture of phenylphosphonic acid and one or more salts of phenylphosphonic acid, especially the calcium salt of phenylphosphonic acid.

A mixture of phenylphosphonic acid and one or more salts of phenylphosphonic acid may be prepared before the surface treatment of the ground natural calcium carbonate.

In the case of a mixture of phenylphosphonic acid and a calcium salt of phenylphosphonic acid the mixture may be prepared before the surface treatment of ground natural calcium carbonate (GNCC) and/or during the surface treatment with phenylphosphonic acid, wherein the calcium salt of phenylphosphonic acid may be formed in situ during the surface treatment with phenylphosphonic acid.

The in situ formation may be controlled by the treatment conditions, such as moisture level, presence of water, temperature, pH value, residence time, etc. and by the ratio of phenylphosphonic acid to ground natural calcium carbonate (GNCC). The progress of the calcium salt formation may be monitored by measuring the pH value of the reaction mixture. When the acidic reaction mixture becomes alkaline, the reaction of phenylphosphonic acid with the calcium carbonate surface is complete.

According to the present invention, it is preferred that the composition comprising calcium carbonate being surface treated with phenylphosphonic acid and/or one or more salt(s) thereof comprises the phenylphosphonic acid and/or one or more salt(s) thereof in an amount ranging from 0.001 to 5 wt %, more preferably from 0.01 to 3 wt %, even more preferably from 0.05 to 2 wt %, most preferably from 0.1 to 1.5 wt % based on the total weight of the ground natural calcium carbonate (GNCC). In one embodiment, the composition comprising calcium carbonate being surface treated with phenylphosphonic acid and/or one or more salt(s) thereof comprises the phenylphosphonic acid and/or one or more salt(s) thereof in an amount ranging from 0.1 to 1.4 wt %, more preferably from 0.2 to 1.4 wt %, even more preferably from 0.2 to 1.3 wt %, most preferably from 0.3 to 1.3 wt % based on the total weight of the ground natural calcium carbonate (GNCC). In particular, the amount of the phenylphosphonic acid and/or one or more salt(s) thereof can be determined by TGA.

It is furthermore preferred that the composition comprising calcium carbonate being surface treated with phenylphosphonic acid and/or one or more salt(s) thereof comprises the phenylphosphonic acid and/or one or more salt(s) thereof in an amount ranging from 0.005 to 20 mg/m², more preferably from 0.01 to 15 mg/m², even more preferably from 0.02 to 10 mg/m², most preferably from 0.05 to 8 mg/m² of the BET specific surface area of the ground natural calcium carbonate (GNCC).

In another preferred embodiment, the composition comprising calcium carbonate being surface treated with phenylphosphonic acid and/or one or more salt(s) thereof may be surface treated with one or more additional treatment agents.

These additional treatment agents may be selected from the group comprising
I) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
II) at least one saturated or unsaturated aliphatic linear or branched carboxylic acid and/or salts thereof, preferably at least one aliphatic carboxylic acid having a total amount of carbon atoms from C₄ to C₂₄ and/or salts thereof, more preferably at least one aliphatic carboxylic acid having a total amount of carbon atoms from C₁₂ to C₂₀ and/or salts thereof, most preferably at least one aliphatic carboxylic acid having a total amount of carbon atoms from C₁₆ to C₁₈ and/or salts thereof, and/or
III) a phosphoric acid ester blend of one or more phosphoric acid mono ester and/or salts thereof and/or one or more phosphoric acid di-ester and/or salts thereof, and/or
IV) at least one polydialkylsiloxane, and/or
V) at least one grafted polymer comprising at least one succinic anhydride group obtained by grafting maleic anhydride onto a homo- or copolymer comprising butadiene units and optionally styrene units and/or salts thereof, or
VI) mixtures of one or more materials according to I) to V).

Thus, the composition comprising calcium carbonate being surface treated with phenylphosphonic acid and/or one or more salt(s) thereof preferably further comprises one or more additional treatment agent(s) selected from the group comprising
I) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof and/or reaction products thereof, and/or
II) at least one saturated or unsaturated aliphatic linear or branched carboxylic acid and/or salts thereof and/or reaction products thereof, preferably at least one aliphatic carboxylic acid having a total amount of carbon atoms from C₄ to C₂₄ and/or salts thereof and/or reaction products thereof, more preferably at least one aliphatic carboxylic acid having a total amount of carbon atoms from C₁₂ to C₂₀ and/or salts thereof and/or reaction products thereof, most preferably at least one aliphatic carboxylic acid having a total amount of carbon atoms from C₁₆ to C₁₈ and/or salts thereof and/or reaction products thereof, and/or
III) a phosphoric acid ester blend of one or more phosphoric acid mono ester and/or salts thereof and/or reaction products thereof and/or one or more phosphoric acid di-ester and/or salts thereof and/or reaction products thereof, and/or
IV) at least one polydialkylsiloxane, and/or
V) at least one grafted polymer comprising at least one succinic anhydride group obtained by grafting maleic anhydride onto a homo- or copolymer comprising butadiene units and optionally styrene units and/or salts thereof and/or reaction products thereof, or
VI) mixtures of one or more materials according to I) to V).

Preferably, the additional treatment agent is selected from the group comprising saturated aliphatic carboxylic acids having a total amount of carbon atoms from C₄ to C₂₄ and/or salts thereof, and especially is stearic acid.

More preferably, the additional treatment agent is selected from the group comprising at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof. For example, the additional treatment agent is selected from the group comprising at least one mono-substituted succinic anhydride consisting of succinic anhydride mono-substituted with a group selected from a linear, branched, aliphatic and cyclic group having a total amount of carbon atoms from at least C₅ to C₂₅, preferably a linear, branched, aliphatic and cyclic group having a total amount of carbon atoms from at least C₁₀ to C₂₅, in the substituent and/or salts thereof.

Most preferably, the additional treatment agent is mono-substituted alkenyl succinic anhydride (ASA). Preferably, the additional treatment agent is mono-substituted alkenyl succinic anhydride having total amount of carbon atoms from at least C₂ to C₃₀, preferably from at least C₅ to C₂₅, and most preferably from at least C₁₀ to C₂₅, in the substituent and/or salts thereof (ASA) For example, the mono-substituted alkenyl succinic anhydride (ASA) is a blend comprising, preferably consisting of, branched octadecenyl succinic anhydrides (CAS No. 28777-98-2) and branched hexadecenyl succinic anhydrides (CAS No. 32072-96-1). It is preferred that more than 80% of the blend contains branched octadecenyl succinic anhydride.

Thus, in a preferred embodiment the composition comprises calcium carbonate being surface treated with phenylphosphonic acid and/or one or more salt(s) thereof and alkenyl succinic anhydride (ASA) and/or salts thereof and/or reaction products thereof.

The additional treatment agent can be added to the ground natural calcium carbonate before, during, or after the treatment with phenylphosphonic acid and/or one or more salt(s) thereof. Preferably, it is added during or after the treatment with phenylphosphonic acid and/or one or more salt(s) thereof. More preferably, the additional treatment agent is added after the treatment with phenylphosphonic acid and/or one or more salt(s) thereof.

According to one embodiment, the composition comprising calcium carbonate being surface treated with phenylphosphonic acid and/or one or more salt(s) thereof comprises the additional treatment agent in an amount ranging from 0.001 to 3 wt %, more preferably from 0.01 to 2 wt %, even more preferably from 0.1 to 1.5 wt %, most preferably from 0.5 to 1.2 wt % based on the total weight of the ground natural calcium carbonate (GNCC). In particular, the amount of the phenylphosphonic acid and/or one or more salt(s) thereof can be determined by TGA. Alternatively, the amount of the additional treatment agent can be based on the total weight of the composition comprising calcium carbonate being surface treated with phenylphosphonic acid and/or one or more salt(s) thereof throughout the present invention.

According to another embodiment, the composition comprising calcium carbonate being surface treated with phenylphosphonic acid and/or one or more salt(s) thereof comprises the additional treatment agent in an amount ranging from 0.001 to 5 mg/m², more preferably from 0.1 to 4 mg/m², even more preferably from 0.5 to 3.5 mg/m², most preferably from 1 to 3 mg/m² of the BET specific surface area of the ground natural calcium carbonate (GNCC).

Thus, the composition comprising calcium carbonate being surface treated with phenylphosphonic acid and/or one or more salt(s) thereof comprises the phenylphosphonic acid and/or one or more salt(s) thereof in an amount ranging from 0.001 to 5 wt %, more preferably from 0.01 to 3 wt %, even more preferably from 0.05 to 2 wt %, most preferably from 0.1 to 1.5 wt % based on the total weight of the ground natural calcium carbonate (GNCC), and the additional treatment agent in an amount ranging from 0.001 to 3 wt %, more preferably from 0.01 to 2 wt %, even more preferably from 0.1 to 1.5 wt %, most preferably from 0.5 to 1.2 wt % based on the total weight of the ground natural calcium carbonate (GNCC). In one embodiment, the composition comprising calcium carbonate being surface treated with phenylphosphonic acid and/or one or more salt(s) thereof comprises the phenylphosphonic acid and/or one or more salt(s) thereof in an amount ranging from 0.1 to 1.4 wt %, more preferably from 0.2 to 1.4 wt %, even more preferably from 0.2 to 1.3 wt %, most preferably from 0.3 to 1.3 wt % based on the total weight of the ground natural calcium carbonate (GNCC), and the additional treatment agent in an amount ranging from 0.001 to 3 wt %, more preferably from 0.01 to 2 wt %, even more preferably from 0.1 to 1.5 wt %, most preferably from 0.5 to 1.2 wt % based on the total weight of the ground natural calcium carbonate (GNCC).

Another aspect of the present invention is a process for manufacturing the composition comprising calcium carbonate being surface treated with phenylphosphonic acid and/or one or more salt(s) thereof as described above.

The process is characterized by the following steps:
a) providing ground natural calcium carbonate (GNCC) in dry form or in the form of a slurry,
b) providing phenylphosphonic acid and/or one or more salt(s) thereof,
c) adding the phenylphosphonic acid and/or one or more salt(s) thereof of step b) to the ground natural calcium carbonate (GNCC) of step a),
to obtain calcium carbonate being at least partially coated with phenylphosphonic acid and/or one or more salt(s) thereof.

In a preferred embodiment of the process of the present invention, the ground natural calcium carbonate (GNCC) is provided in dry form or in the form of an aqueous slurry.

It is an important advantage of the present invention that no organic solvent such as e.g. acetone has to be used, but that the process may be successfully carried out as a dry process or in an aqueous medium.

If the ground natural calcium carbonate (GNCC) is provided in the form of an aqueous slurry, the slurry may have a solids content of from 1 wt % to 80 wt %, more preferably 5 wt % to 72 wt %, even more preferably 10 wt % to 60 wt %, especially preferably 15 wt % to 50 wt %, and most preferably 20 to 40 wt % based on the total weight of the slurry.

A “suspension” or “slurry” in the meaning of the present invention refers to a mixture comprising at least one insoluble solid in a liquid medium, for example water, and optionally further additives, and usually contains large amounts of solids and, thus, is more viscous (higher viscosity) and can have a higher density than the liquid medium from which it is formed.

If the ground natural calcium carbonate (GNCC) is provided in dry form, this means that the ground natural calcium carbonate (GNCC) preferably has a residual total moisture content of ≤0.5 wt %, preferably ≤0.3 wt %, even more preferably ≤0.2 wt %, and most preferably ≤0.15 wt %, e.g. from 0.02 to 0.1 wt %, based on the total dry weight of the natural ground calcium carbonate.

In step b), phenylphosphonic acid and/or one or more salt(s) thereof are provided, wherein phenylphosphonic acid is preferred.

The phenylphosphonic acid may be provided dry, or, preferably, it may be provided in the form of an aqueous solution, containing from 10 to 50 wt %, preferably from 15 to 40 wt %, more preferably from 20 to 30 wt %, even more preferably from 22 to 28 wt %, most preferably from 24 to 26 wt % phenylphosphonic acid, based on the total weight of the solution.

In another preferred embodiment, one or more salt(s) of phenylphosphonic acid may be provided. The salt(s) may be selected from the group comprising alkali salts, such as lithium, sodium, potassium salts; alkaline earth salts, such as calcium, magnesium, barium salts; transition metal salts, such as zinc salts, and mixtures thereof.

The phenylphosphonic acid salt(s) may be provided in the dry form or in the form of an aqueous slurry or solution.

If the phenylphosphonic acid salt(s) are provided in the form of a slurry or solution, they are contained in the slurry or solution in an amount of from 10 to 50 wt %, preferably from 15 to 40 wt %, more preferably from 20 to 30 wt %, even more preferably from 22 to 28 wt %, most preferably from 24 to 26 wt %, based on the total weight of the slurry or solution.

According to step c), the phenylphosphonic acid and/or one or more salt(s) thereof is added to the ground natural calcium carbonate (GNCC). This is important in order to provide an even reaction of the phenylphosphonic acid and/or salt molecules with the calcium carbonate surface.

Furthermore, it is preferred to provide ground natural calcium carbonate (GNCC) in the dry form and phenylphosphonic acid and/or one or more salt(s) thereof in the dry form, and to add the phenylphosphonic acid and/or one or more salt(s) thereof to the ground natural calcium carbonate (GNCC).

In a further preferred embodiment, ground natural calcium carbonate (GNCC) is provided in the dry form, the phenylphosphonic acid and/or one or more salt(s) thereof is provided in the form of an aqueous solution or slurry, and the aqueous solution or slurry of phenylphosphonic acid and/or one or more salt(s) thereof is added to the dry ground natural calcium carbonate (GNCC).

In a still further preferred embodiment, ground natural calcium carbonate (GNCC) is provided in the form of an aqueous slurry, the phenylphosphonic acid and/or one or more salt(s) thereof is provided in the form of an aqueous solution or slurry, and the aqueous solution or slurry of phenylphosphonic acid and/or one or more salt(s) thereof is added to the ground natural calcium carbonate (GNCC) slurry.

In another preferred embodiment, ground natural calcium carbonate (GNCC) is provided in the form of an aqueous slurry, the phenylphosphonic acid and/or one or more salt(s) thereof is provided in the dry form, and the dry phenylphosphonic acid and/or one or more salt(s) thereof is added to the ground natural calcium carbonate (GNCC) slurry.

In an especially preferred embodiment, dry ground natural calcium carbonate (GNCC) and a phenylphosphonic acid solution is provided, and the phenylphosphonic acid solution is added to the dry ground natural calcium carbonate (GNCC).

In a further advantageous embodiment, dry ground natural calcium carbonate (GNCC) and a dry phenylphosphonic acid salt, preferably calcium salt, is provided, and the dry phenylphosphonic acid salt, preferably calcium salt, is added to the dry ground natural calcium carbonate (GNCC).

Phenylphosphonic acid may also be used together with some coupling agents, where phenylphosphonic acid has some limited solubility. Such coupling agents may be selected from the group comprising dioctylphosphonate, phosphite titanates or zirconates, silane coupling agents such as triethoxysilane.

If the composition comprising calcium carbonate being surface treated with phenylphosphonic acid and/or one or more salt(s) thereof is further surface treated with one or more additional treatment agent(s), it is appreciated that this step is preferably carried out before, during, or after step c). Preferably, the step of adding the additional treatment agent(s) is added after step c).

Furthermore, it is preferred that during and/or after the addition of phenylphosphonic acid and/or salt(s) thereof of step b) to the ground natural calcium carbonate (GNCC) of step a) (step c)), a mixing step (step d)) is carried out.

The addition of phenylphosphonic acid and/or salt(s) thereof to the ground natural calcium carbonate (GNCC) may be carried out by mixing, preferably by stirring or kneading.

In a further preferred embodiment, the mixing is carried out after the addition of phenylphosphonic acid and/or salt(s) thereof to the ground natural calcium carbonate (GNCC).

In an especially preferred embodiment, the addition of phenylphosphonic acid and/or salt(s) thereof to the ground natural calcium carbonate (GNCC) is carried out by mixing, which is continued after the addition step.

The mixing step is preferably carried out until a homogeneous mixture is obtained. Homogeneous in the meaning of the present invention means that the components are distributed uniformly.

Suitable mixing equipment may be any conventional equipment known by the skilled person for such purposes, such as e.g. a high shear mixer, a ribbon mixer, a plough shear mixer, a paddle mixer, a tumble blender, a vertical blender, an overhead stirrer, etc.

The skilled man will adapt the mixing conditions (such as the configuration of mixing time and mixing speed) according to his process equipment.

According to another embodiment of the present invention, the mixing step may be carried out in a milling device, for example, in a ball mill, a rod mill, a vibrating mill, a roll crusher, a centrifugal impact mill, a vertical bead mill, an attrition mill, a pin mill, a cell mill or a hammer mill.

If the mixing is carried out with dry components, the use of a high shear mixer, a pin mill or a cell mill may be especially preferred.

If one or several components are provided as an aqueous solution or slurry, it may be preferred to use grinding equipment, such a ball mill, wherein, optionally, a dispersant may be added. Mixing step d) may be carried out at temperatures of from 15° C. to 150° C., preferably at temperatures from 20° C. to 120° C., most preferably from 40 to 90° C.

According to one embodiment of the present invention, process step d) is carried out for at least 1 s, preferably for at least 1 min, e.g. for at least 15 min, 30 min, 45 min or 1 hour.

It is also possible to add the concentrated aqueous solution to dry calcium carbonate in a mixing equipment (e.g. pin mill or cell mill), preferably at a temperature 40 to 120° C.

The product obtained after step c) or optional step d) may be dried (step e)).

Drying may be carried out mechanically, thermally, or by a combination of mechanical and thermal drying, optionally under vacuum.

Mechanical drying may be carried out in one or more of a centrifuge, a filtration device, a rotary vacuum filter, a filter press and/or tube press.

Thermal drying may be carried out by one or more of a spray dryer and a heat exchanger, cell mill, jet dryer, oven, compartment dryer, vacuum dryer, microwave dryer and/or freeze dryer.

Drying may also be carried out by a combination of mechanical and thermal drying, e.g. a combination of centrifuge and thermal drying such as with hot air or fluidized bed.

The product obtained by this process is a ground natural calcium carbonate (GNCC) being surface treated with phenylphosphonic acid and/or one or more salt(s) thereof.

As described above, surface treatment according to the present invention means that the phenylphosphonic acid and/or one or more salt(s) thereof is associated with the surface of the ground natural calcium carbonate (GNCC). This may include an association by physical mechanisms such electrostatic attraction, and/or by chemical mechanisms, such as a chemical reaction of the phenylphosphonic acid and/or one or more salt(s) thereof with the surface of the ground natural calcium carbonate (GNCC).

Accordingly, the ground natural calcium carbonate (GNCC) is at least partially coated with phenylphosphonic acid and/or one or more salt(s) thereof.

In a preferred embodiment, the ground natural calcium carbonate (GNCC) is at least partially coated with phenylphosphonic acid.

In another preferred embodiment, the ground natural calcium carbonate (GNCC) is at least partially coated with one or more salt(s) of phenylphosphonic acid, which may be selected from the group comprising alkali salts, such as lithium, sodium, potassium salts; alkaline earth salts, such as calcium, magnesium, barium salts; transition metal salts, such as zinc salts, and mixtures thereof, wherein the sodium or calcium salt of phenylphosphonic acid is especially preferred, and the calcium salt of phenylphosphonic acid is most preferred.

If a phenylphosphonic acid calcium salt is used, it may be prepared before the surface treatment of the ground natural calcium carbonate and/or may be formed in situ during the surface treatment with phenylphosphonic acid.

In a still further preferred embodiment, the ground natural calcium carbonate (GNCC) is at least partially coated with a mixture of phenylphosphonic acid and one or more salts of phenylphosphonic acid, especially the calcium salt of phenylphosphonic acid.

A mixture of phenylphosphonic acid and one or more salts of phenylphosphonic acid may be prepared before the surface treatment of the ground natural calcium carbonate.

In the case of a mixture of phenylphosphonic acid and a calcium salt of phenylphosphonic acid, the mixture may be prepared before the surface treatment of ground natural calcium carbonate (GNCC) and/or during the surface treatment with phenylphosphonic acid, wherein the calcium salt of phenylphosphonic acid may be formed in situ during the surface treatment with phenylphosphonic acid.

The in situ formation may be controlled by the treatment conditions, such as moisture level, presence of water, temperature, pH value, residence time, etc. and by the ratio of phenylphosphonic acid to ground natural calcium carbonate (GNCC). The progress of the calcium salt formation may be monitored by measuring the pH value of the reaction mixture. When the acidic reaction mixture becomes alkaline, the reaction of phenylphosphonic acid with the calcium carbonate surface is complete.

The phenylphosphonic acid and/or one or more salt(s) thereof may be added to the ground natural calcium carbonate (GNCC) in an amount of from 0.005 to 20 mg/m², preferably from 0.01 to 15 mg/m², more preferably from 0.02 to 10 mg/m², most preferably from 0.05 to 8 mg/m² of the BET specific surface area of the ground natural calcium carbonate (GNCC).

In another preferred embodiment, it may be preferred that the phenylphosphonic acid and/or one or more salt(s) thereof is added to the ground natural calcium carbonate (GNCC) in an amount of from 0.001 to 5 wt %, preferably from 0.01 to 3 wt %, more preferably from 0.05 to 2 wt %, most preferably from 0.1 to 1.5 wt % based on the weight of the ground natural calcium carbonate (GNCC). For example, the phenylphosphonic acid and/or one or more salt(s) thereof is added to the ground natural calcium carbonate (GNCC) in an amount ranging from 0.1 to 1.4 wt %, more preferably from 0.2 to 1.4 wt %, even more preferably from 0.2 to 1.3 wt %, most preferably from 0.3 to 1.3 wt % based on the total weight of the ground natural calcium carbonate (GNCC).

A further aspect of the present invention relates to a composition comprising ground natural calcium carbonate (GNCC) being surface treated with phenylphosphonic acid and/or one or more salt(s) thereof obtained by the process described above.

It has been found that the composition comprising ground natural calcium carbonate (GNCC) being surface treated with phenylphosphonic acid and/or one or more salt(s) thereof as described above may be advantageously used as a nucleating agent in polymer formulations.

Accordingly, a further aspect of the present invention is the use of the composition comprising ground natural calcium carbonate being surface treated with phenylphosphonic acid and/or one or more salt(s) thereof according to the invention as a nucleating agent in the production of polymer formulations.

The polymer formulation preferably is selected from polyester formulations, more preferably is selected from the group comprising polylactic acid (PLA) formulations, including poly L-lactic acid (PLLA) formulations, poly D-lactic acid (PDLA) formulations, poly DL-lactic acid (PDLLA) formulations; polyhydroxyalkanoate (PHA) formulations, e.g. polyhydroxybutyrate (PHB) formulations; polybutylenadipat-terephthalat (PBAT) formulations; polybutylene succinate (PBS) formulations; and mixtures thereof. Especially preferred polymer formulations are selected from polylactic acid (PLA) formulations and/or polyhydroxyalkanoate (PHA) formulations.

Most preferably, the polymer formulation is a polylactic acid (PLA) formulation, or a mixture thereof with one or more of the polymers mentioned above. Especially, the polymer formulation is a poly L-lactic acid (PLLA) formulation, or a mixture thereof with one or more of the polymers mentioned above.

Accordingly, a further aspect of the present invention is a nucleating agent comprising a composition comprising ground natural calcium carbonate being surface treated with phenylphosphonic acid and/or one or more salt(s) thereof as described above.

In view of the use of the composition comprising ground natural calcium carbonate being surface treated with phenylphosphonic acid and/or one or more salt(s) thereof according to the invention as a nucleating agent in polymer formulations, a still further aspect of the invention are polymer formulations comprising a composition comprising ground natural calcium carbonate being surface treated with phenylphosphonic acid and/or one or more salt(s) thereof as described above.

A “polymer formulation” according to the present invention refers to a composition comprising at least one polymer component and the composition comprising ground natural calcium carbonate being surface treated with phenylphosphonic acid and/or one or more salt(s) thereof.

The polymer formulation preferably is selected from polyester formulations, and more preferably is selected from the group comprising polylactic acid (PLA) formulations, including poly L-lactic acid (PLLA) formulations, poly D-lactic acid (PDLA) formulations, poly DL-lactic acid (PDLLA) formulations; polyhydroxyalkanoate (PHA) formulations, e.g. polyhydroxybutyrate (PHB) formulations; polybutylenadipat-terephthalat (PBAT) formulations; polybutylene succinate (PBS) formulations; and mixtures thereof.

Most preferably, the polymer formulation is a poly L-lactic acid (PLLA) formulations, or a poly L-lactic acid (PLLA) formulation in combination with one or more of the other polymer formulations mentioned above.

In an advantageous embodiment, the polymer formulation comprises the composition comprising ground natural calcium carbonate being surface treated with phenylphosphonic acid and/or one or more salt(s) thereof in an amount of from 0.01 to 70 wt %, preferably from 0.05 to 50 wt %, more preferably from 0.1 to 25 wt %, even more preferably from 0.5 to 10 wt %, most preferably from 1 to 5 wt % relating to the amount of polymer.

According to the invention, the polymer formulation comprising a composition comprising ground natural calcium carbonate being surface treated with phenylphosphonic acid and/or one or more salt(s) thereof as described above is prepared by the following steps:
a) providing a polymer;
b) providing the composition comprising ground natural calcium carbonate being surface treated with phenylphosphonic acid and/or one or more salt(s) thereof and optional additional surface treatment agent(s);
c) contacting the polymer of step a) with the composition of step b),
d) blending the contacted components of step c).

Contacting step c) and/or blending step d) may be carried out by any technique being suitable therefor, e.g. melt blending, by means of a paddle mixer, tumbler blender, ribbon mixer, by compounding, e.g. with an extruder such as a twin screw extruder or a co-kneader, by injection moulding, etc.

The term “compounding” according to the present invention refers to the preparation of a polymer or plastic formulation by mixing and/or blending at least one polymer component with at least one additive, such as the composition comprising ground natural calcium carbonate being surface treated with phenylphosphonic acid and/or one or more salt(s) thereof in a molten or softened state in order to achieve a homogenous blend of the different raw materials. The dispersive and distributive mixing is performed at temperatures at which the polymer components are in a molten or softened state but below decomposition temperature.

According to one embodiment of the present invention blending may take place by means of a dough kneader. Dough kneaders are able to mix and knead compositions and particularly those with a high viscosity. Dough kneaders function by rotating one or more Sigma- or Z-type blades horizontally inside a bowl or dish. Equipment that may be used is available, for example, from Kenwood Ltd.

According to another embodiment of the present invention blending may take place by means of an extruder, for example a single or a twin screw extruder. Extruders are able to mix and compound compositions. Extruders function by rotating one or more screws inside a housing. Equipment that may be used may comprise a base unit and an extruder. For example, the base unit may be a Haake Polylab OS from Thermo Scientific and the extruder may be a Rheomix CTW 100 OS from Thermo Scientific.

According to another embodiment of the present invention blending may take place by means of a laboratory compounder. Laboratory compounders are able to mix and knead compositions. Equipment that may be used may comprise a base unit, a compounder, and a kneader. For example, the base unit may be a Haake Polylab OS, the compounder may be a Haake Rheomix 600 OS and the kneader may be a Roller Roters 600, all from Thermo Scientific. RheoDrive7 may be used as software for evaluating the test results.

According to another embodiment of the present invention blending may take place by means of a twin roll mill. Twin roll mills are able to mix and knead compositions. An exemplary roll mill is the Walzwerk 150×400 from Dr. Collin GmbH, Germany.

Contacting and, especially, blending may be carried out at temperatures above the melting point of the polymer(s), e.g. for PLA, at a temperature of from 160° C. to 220° C., preferably 170° to 210° C.

For PHA, temperatures might be slightly lower, e.g. between 130° C. and 190° C. or between 130° C. and 170° C. depending on the PHA grade, etc.

The polymer formulations are suitable for the use in a number of technical fields, e.g. in the field of 3D printing, injection molding, thermoforming, cast film extrusion, blown film extrusion, blow molding, hot press, etc.

The polymer formulations according to the invention may be used, e.g., in the production of articles selected from the group comprising cups, straws, cutlery, such as forks, knives, spoons, plates, bottles, automotive pieces.

The following examples and tests will illustrate the present invention, but are not intended to limit the invention in any way.

### DESCRIPTION OF THE FIGURES

FIG. 1 shows DSC thermograms (method a)) during a cooling at 10 K/min for the polymer formulations obtained by melt blending.

FIG. 2 shows the half-time of crystallization plots for compounds with 5 wt % nucleation agent according to the invention and compounds with 5 wt % talc.

FIG. 3 shows the half-time crystallization (min) of extruded compounds measured with DSC method c) at a cooling rate at 10K/min for samples comprising 0.5 w % PPA.

FIG. 4 shows the half-time crystallization (min) of extruded compounds measured with DSC method c) at a cooling rate at 10K/min for samples comprising 0.5 w % PPA+0.7 wt % ASA.

FIG. 5 shows the half-time crystallization (min) of extruded compounds measured with DSC method c) at a cooling rate at 10K/min for samples comprising 0.1 w % PPA.

### EXAMPLES

### 1. Measurement Methods

The following measurement methods are used to evaluate the parameters given in the examples and claims.

### Particle Size Distribution

Volume determined median particle size d₅₀ (vol) and the volume determined top cut particle size d₉₈ (vol) as well as the volume particle sizes d₉₀ (vol) and d₁₀ (vol) may be evaluated in a wet unit using a Malvern Mastersizer 2000 or 3000 Laser Diffraction System (Malvern Instruments Plc., Great Britain). If not otherwise indicated in the following example section, the volume particle sizes were evaluated in a wet unit using a Malvern Mastersizer 2000 Laser Diffraction System (Malvern Instruments Plc., Great Britain). The d₅₀ (vol) or d₉₈ (vol) value indicates a diameter value such that 50% or 98% by volume, respectively, of the particles have a diameter of less than this value. The raw data obtained by the measurement was analyzed using the Mie theory, with a particle refractive index of 1.57 and an absorption index of 0.005. The methods and instruments are known to the skilled person and are commonly used to determine particle size distributions of fillers and pigments. The sample was measured in dry condition without any prior treatment.

The weight determined median particle size d₅₀ (wt) was measured by the sedimentation method, which is an analysis of sedimentation behaviour in a gravimetric field. The measurement was made with a Sedigraph™ 5120 of Micromeritics Instrument Corporation, USA. The method and the instrument are known to the skilled person and are commonly used to determine particle size distributions of fillers and pigments. The measurement was carried out in an aqueous solution of 0.1 wt % Na₄P₂O₇. The samples were dispersed using a high speed stirrer and supersonicated.

The processes and instruments are known to the skilled person and are commonly used to determine particle sizes of fillers and pigments.

### BET Specific Surface Area of a Material

The “specific surface area” (expressed in m²/g) of a material as used throughout the present document is determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 60 min prior to measurement. The total surface area (in m²) of said material can be obtained by multiplication of the specific surface area (in m²/g) and the mass (in g) of the material.

pH

Any pH value is measured at 25° C. using a Mettler-Toledo Seven Easy PH meter and a Mettler-Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

### TGA

The amount of phenylphosphonic acid and/or one or more salt(s) thereof in the composition comprising calcium carbonate being surface treated with phenylphosphonic acid and/or one or more salt(s) thereof, was determined by TGA. The equipment used to measure the TGA was the Mettler-Toledo TGA/DSC3+ (STARe System) and the crucibles used were aluminium oxide 150 μl. The method consists of several heating steps under air (80 ml/min). The first step was a heating from 25 to 150° C. at a heating rate of 20° C./minute (step 1), then the temperature was maintained for 10 minutes at 150° C. (step 2), then heating was continued at a heating rate of 20° C./minute from 150 to 550° C. (step 3). The temperature was then maintained at 550° C. for 10 minutes (step 4), and finally, heating is continued at a heating rate of 20° C./minute from 550 to 600° C. (step 5). The amount of phenylphosphonic acid and/or one or more salt(s) thereof is assessed by using the cumulated weight loss of step 3 and step 4, and subtracting the weight loss of step 3 and 4 for the untreated calcium carbonate.

### Amount of Surface-Treatment Layer

The amount of the treatment layer on the ground natural calcium carbonate or composition is calculated theoretically from the values of the BET of the untreated ground natural calcium carbonate or composition and the amount of treatment agent that is used for the surface treatment. It is assumed that 100% of the treatment agent added to the ground natural calcium carbonate or the composition are present as surface treatment layer on the surface of the ground natural calcium carbonate or the composition.

### Differential Scanning Calorimetry (DSC) Analysis

The DSC analysis was carried out with a heat flux type Mettler Toledo DSC 1. 3 methods were used to characterize the crystallization behaviors of the PLA compounds with different fillers/additives:
a) Cooling rate of 10 K/min, with program below:

| | | | | |
|---|---|---|---|---|
| [1] | −15° C., | 2 | min, | N₂ 50 ml/min |
| [2] | −15° C. to 220.0° C., | 10 | K/min, | N₂ 50 ml/min |
| [3] | 220° C., | 2 | min, | N₂ 50 ml/min |
| [4] | 220° C. to −15.0° C., | −10.00 | K/min, | N₂ 50 ml/min |
| [5] | −15° C., | 2.00 | min, | N₂ 50 ml/min |
| [6] | −15° C. to 220° C., | 10.00 | K/min, | N₂ 50 ml/min |

b) Different cooling rates, namely 20, 30 or 50 K/min with programs below:

| | | | | |
|---|---|---|---|---|
| [1]: | −15° C., | 2 | min, | N₂ 50 ml/min |
| [2]: | −15° C. to 220° C., | 10 | K/min, | N₂ 50 ml/min |
| [3]: | 220° C., | 2 | min, | N₂ 50 ml/min |
| [4]: | 220° C. to −15° C., | XX | K/min, | N₂ 50 ml/min |
| [5]: | −15° C., | 2 | min, | N₂ 50 ml/min |
| [6]: | −15° C. to 220° C., | 10 | K/min, | N₂ 50 ml/min |

Where XX is either 20, 30 or 50 K/min

c) Isothermal crystallization at 120, 130, 135 and 140° C., with following program:

| [1]: | 25° C. to 220° C., | 50 | K/min, | N₂ 50 ml/min |
|---|---|---|---|---|
| [2]: | 220° C., | 2 | min, | N₂ 50 ml/min |
| [3]: | 220° C. to XXX ° C., | −30 | K/min, | N₂ 50 ml/min |
| [4]: | XXX ° C., | 30 to 60 min | | N₂ 50 ml/min |
| | | (depending on | | |
| | | temperature), | | |
| [5]: | XXX ° C. to 20° C., | −50 | K/min, | N₂ 50 ml/min |

Where XXX is either 120, 130, 135 or 140° C.

DSC analysis was conducted with a Mettler Toledo DSC 3. With the method a) and b), the onset, peak crystallization temperature, crystallization enthalpy were evaluated. With method c) the half-time of crystallization was assessed.

### Ash Content

Ash content in [%] of the compounds was determined by incineration of a sample in a crucible which is put into a muffle furnace following the temperature cycles described in the table below. Ash content measurement was used to verify the mineral filler loading in the compound is the same as theoretical value by dosing.

| Cycle | 1 | 2 | 3 | 4 |
|---|---|---|---|---|
| Temperature (° C.) | 330 | 480 | 570 | 570 |
| Time (min) | 85 | 100 | 25 | 120 |
| Ramp (° C./min) | 3.6 | 1.5 | 3.6 | 0 |
| Ventilation | — | on | on | — |

### 2. Materials

Phenylphosphonic acid (PPA): 98% purity from Sigma-Aldrich
Alkenyl succinic anhydride (ASA): mono-substituted alkenyl succinic anhydride (mono-C₁₅₋₂₀-alkenyl derivatives of dihydro-2,5-furandione, CAS No. 68784-12-3), which is a blend of mainly branched octadecenyl succinic anhydrides (CAS No. 28777-98-2) and mainly branched hexadecenyl succinic anhydrides (CAS No. 32072-96-1). More than 80% of the blend are branched octadecenyl succinic anhydrides. The purity of the blend is >95 wt %. The residual olefin content is below 3 wt %.
Calcium hydroxide: 96% purity from Sigma Aldrich.
PLA Luminy® L130: Polylactic acid (PLA) from Total Corbion.
PLA Ingeo 6100D Calcium carbonate: Polylactic acid (PLA) from NatureWorks.
Calcium carbonate 1 is a wet ground and spray dried marble from China having a d₅₀ of 2.2 μm, a d₉₈ of 8.1 μm and a BET specific surface area of 4.0 m²/g.
Calcium carbonate 2 is another wet ground spray dried marble from Italy having a d₅₀ of 2.3 μm, a d₉₈ of 8.9 μm and a BET specific surface area of 4.1 m²/g.
Treated calcium carbonate 1 is calcium carbonate 2 as raw material and treated with ASA (CC2ASA (0.7 wt %; dry).
Calcium carbonate 3 is a dry ground marble from India with a d₆₀ of 2.9 μm, a des of 12 μm and a BET specific surface area of 2.8 m²/g.
Calcium carbonate 4 is a dry ground marble from Italy with a d₅₀ of 1.7 μm, a d₉₈ of 8 μm and a BET specific surface area of 3.6 m²/g.
Calcium carbonate 5 is a precipitated calcium carbonate from Austria with a d₅₀ of 2 μm, a d₉₈ of 5 μm of and a BET specific surface area of 70 m²/g.
Calcium carbonate 6 is a wet ground eggshells-based calcium carbonate, then dried at 220° C. from Portugal with a d₅₀ of 1.5 μm, a d₉₈ of 8 μm of and a BET specific surface area of 6.6 m²/g.
Talc: PlusTalc H05 from Elementis.
Calcium salt of phenylphosphonic acid: was prepared as follows:

### Preparation of Calcium Salt of Phenylphosphonic Acid (CaPPA)

Ca-PPA powder was prepared in a 2 I beaker. 1.58 g of PPA (Mw=158.1 g/mol, 10 mmol) was dissolved in 200 ml deionized water. The solution was heated with stirring to 50° C., and 10 mmol of Ca(OH)₂ dissolved in water were added (74.1 g/mol, 10 mmol, 0.74 g).

After stirring for 1 h, the mixture was filtered on a pressure filtration unit, redispersed in water, filtered again and dried in the oven (100° C.) to obtain a white powder (1.68 g, 89% yield). The obtained CaPPA is not water-soluble but hygroscopic. It was kept in a desiccator for subsequent use.

### 3. Preparation of Compositions According to the Invention

Preparation of a Composition Comprising Calcium Carbonate being Surface Treated with Calcium Salt of Phenylphosphonic Acid (CaPPA) (Dry Process)

CaPPA was added to calcium carbonate 1 with a Somakon high shear mixer (Somakon Verfahrenstechnik GmbH, Germany).

450 g of calcium carbonate 1 was added in the dry-mixer and the main rotor was maintained at 600 rpm without further heating for the mixing vessel. 4.5 g of CaPPA was added into the vessel in 2 minutes. After completion of CaPPA, the mixture was allowed further mixing for 10 minutes at 800 rpm. The treated Calcium carbonate 1 was not agglomerated and still in powder form. It was dried in an oven at 105° C. overnight. The CaPPA loading on the calcium carbonate 1 is 1 wt %. The composition obtained is designated CC1CaPPA (1%, dry)

Preparation of a Composition Comprising Calcium Carbonate being Surface Treated with Phenylphosphonic Acid (PPA) (Wet Process)

The phenylphosphonic acid solution was added to the calcium carbonate slurry, such that the phenylphosphonic acid molecules can react with the calcium carbonate surface evenly.

40 g of calcium carbonate 1 was dispersed in 400 ml of deionized water. While maintaining agitation with an overhead stirrer at 600 rpm, an aqueous solution containing 0.41 g (25% active) of PPA (1 wt % based on calcium carbonate weight) was slowly added into the slurry within 2 minutes. The slurry pH was immediately measured and was alkaline. The reaction between calcium carbonate and PPA is instant and forming calcium salt of PPA, which is insoluble in water. The slurry was dried in an oven at 120° C. overnight and deagglomerated for subsequent application study. The CaPPA loading on the calcium carbonate 1 is 1.24 wt %, which is equivalent to PPA 1%.

The composition obtained is designated CC1PPA (1%, wet)

This process is easily scaled up by adding/dosing PPA solution before the separation of calcium carbonate particles with water phase in a typical wet-process line for dry products.

Preparation of a Composition Comprising Calcium Carbonate being Surface Treated with Phenylphosphonic Acid (PPA) (Dry Process)

PPA was added to each of calcium carbonate 1, calcium carbonate 2, calcium carbonate 4, calcium carbonate 5 or calcium carbonate 6 with a Somakon high shear mixer (Somakon Verfahrenstechnik GmbH, Germany).

450 g of calcium carbonate 1 was added in the dry-mixer and the main rotor was maintained at 600 rpm without further heating for the mixing vessel. 18 g of PPA aqueous solution (25 wt % active) was added into the vessel in 2 minutes. After completion of PPA addition, the mixture was allowed further mixing for 10 minutes at 800 rpm. The treated calcium carbonate 1 was not agglomerated and still in powder form. The treated calcium carbonate 1 was put in an oven at 105° C. overnight. The dried powder was used for further application without further process such as deagglomeration. The PPA loading on the calcium carbonates 1 and 2 is 1 wt %.

The compositions obtained are designated CC1PPA (1%, dry) and CC2PPA (1%, dry).

With the high efficiency of PPA coating on calcium carbonate particles, the PPA loading can be even lowered to 0.1 wt % and thus minimum of water is introduced with PPA aqueous solution and thus the drying of the finished product can be omitted. At such a low coating level of 0.1 wt % PPA, the treatment is conducted with oil bath temperature of 100° C. and thus the contents maintained at 90° C. in the mixing vessel. After the addition of the PPA aqueous solution, the content was further mixed at 750 rpm for 15 minutes in order to mix well and remove the excess moisture. This adapted procedure was done for calcium carbonates 1, 2, 4, 5 and 6.

The compositions obtained are designated CC1PPA (0.1%, dry) and CC2PPA (0.1%, dry), CC4PPA (0.1%, dry), CC5PPA (0.1% dry), CC6PPA (0.1%, dry).

An intermediate coating level was also produced with calcium carbonate 4, 5 and 6 with a PPA level of 0.5 wt % following the same adapted procedure as for the coating level of 0.1 wt %.

The compositions obtained are designated CC4PPA (0.5%, dry), CC5PPA (0.5%, dry) and CC6PPA (0.5%, dry).

Preparation of a Composition Comprising Calcium Carbonate being Surface Treated with Phenylphosphonic Acid (PPA) and Alkenyl Succinic Anhydride (ASA) (Dry Process)

The ground natural calcium carbonate was surface treated with PPA and ASA with a Somakon high shear mixer (Somakon Verfahrenstechnik GmbH, Germany).

450 g of calcium carbonate 1 was added in the dry-mixer and the main rotor was maintained at 600 rpm without further heating for the mixing vessel. 1.8 g of PPA aqueous solution (25% active) was added into the vessel in 2 minutes. After completion of PPA addition, the mixture was allowed further mixing for 15 minutes at 800 rpm. ASA (0.7 wt % based on calcium carbonate 1 weight) was added 15 minutes after PPA addition. During the ASA addition, mixing speed was reduced to 200 rpm in order to avoid excessively splashing of powder. After ASA addition completion, mixing speed was increased again to 750 rpm and mixing was continued for 15 minutes to complete the dual coating. The treatment was carried out at a temperature of 90° C. The treated product was unloaded and packed for further analysis and application study.

The composition obtained is designated CC1PPAASA (0.1%, 0.7%, dry).

The same procedure was carried out for calcium carbonates 4, 5 and 6, whereby the coating level of PPA was adapted to 0.5 wt %, based on the total weight of calcium carbonate. After the coating, the powder was unloaded and put in an oven at 105° C. overnight. The PPA loading on the calcium carbonate 4, 5 or 6 was 0.5 wt % and the ASA loading was 0.7 wt %, each based on the total weight of the respective calcium carbonate.

The compositions obtained are designated CC4PPAASA (0.5%, 0.7%, dry), CC5PPAASA (0.5%, 0.7%, dry), CC6PPAASA (0.5%, 0.7%, dry).

Preparation of a Calcium Carbonate being Surface Treated with Alkenyl Succinic Anhydride (ASA) (Dry Process) (Comparative)

Furthermore, a comparative sample was prepared according to the above dry process, with the exception that calcium carbonate 3 was used, and ASA only.

450 g of calcium carbonate 3 was added in the dry-mixer and the main rotor was maintained at 600 rpm without further heating for the mixing vessel. ASA (0.7 wt % based on calcium carbonate 3 weight) was added. During the ASA addition, mixing speed was reduced to 200 rpm in order to avoid excessively splashing of powder. After ASA addition completion, mixing speed was increased to 750 rpm and mixing was continued for 15 minutes to complete the coating. The treatment was carried out at a temperature of 90° C. The treated product was unloaded and packed for further analysis and application study.

The composition obtained is designated CC3ASA (0.7%, dry).

### 4. Preparation of Polymer Formulations

### Melt Blending

PLA L130 was kept dry before conducting melt blending. A total weight of 40 g of all components with PLA L130 was dry mixed in a plastic cup. The melt blend was prepared with Haake Rheomix at 190° C., with rotor speed of 40 rpm for 6 minutes to ensure good mixing without degradation. The blends were collected for further DSC analysis. The compositions are listed in Table 1 in wt %.

TABLE 1
Formulations of PLA L130 with melt blending by Rheomix.

| | L0 | L1 | L2 | L3 | L4 | L5 | L6 | L7 | L8 | L9 | L10 |
|---|---|---|---|---|---|---|---|---|---|---|---|
| PLA L130 | 100 | 98 | 80 | 80 | 80 | 90 | 95 | 80 | 80 | 80 | 80 |
| CaPPA | | 2 | | | | | | | | | |
| CC1PPA | | | 20 | | | | | | | | |
| (1%, wet) | | | | | | | | | | | |
| CC1CaPPA | | | | 20 | | | | | | | |
| (1%, dry) | | | | | | | | | | | |
| CC1PPA | | | | | 20 | 10 | 5 | | | | |
| (1%, dry) | | | | | | | | | | | |
| Calcium | | | | | | | | 20 | | | |
| Carbonate 1 | | | | | | | | | | | |
| (untreated) | | | | | | | | | | | |
| PlusTalc H05 | | | | | | | | | 20 | | |
| CC1CaPPA | | | | | | | | | | 20 | |
| (0.1%, dry) | | | | | | | | | | | |
| CC1PPAASA | | | | | | | | | | | 20 |
| (0.1%, 0.7%, | | | | | | | | | | | |
| dry) | | | | | | | | | | | |

Compounding with Extruder and Injection Molding

Compounding was conducted with Lab type twin-screw extruder model ZE12 with L/D 25:1 and die 0.5 mm from Three-Tec. PLA Ingeo 6100D from Natureworks was first crushed to <1 mm particles with a Retsch SR300 rotor beater mill and dried 2 hours at 70° C. prior to compounding. The PLA 6100D and filler/additives are premixed and add into the hopper. Temperature profile of the barrel are:

$$T 1 = 170 ° C .$$

$$T 2 = 190 ° C .$$

$$T 3 = 190 ° C .$$

$$T 4 = 180 ° C .$$

After extrusion, the strand is pelletized and collected for further analysis such as thermal analysis or ashing or injection molding. The compositions are listed in Table 2 in wt %.

TABLE 2a
Formulations of PLA 6100D compounded
with extruder and injection molding

| | C0 | C1 | C2 | C3 | C4 | C5 | C6 | C7 | C8 | C9 |
|---|---|---|---|---|---|---|---|---|---|---|
| PLA 6100D | 100 | 95 | 95 | 95 | 95 | 95 | 95 | 95 | 95 | 90 |
| Calcium | | 5 | | | | | | | | |
| carbonate 1 | | | | | | | | | | |
| CC1PPA | | | 5 | | | | | | | |
| (0.1%, dry) | | | | | | | | | | |
| CC1PPAASA | | | | 5 | | | | | | |
| (0.1%, 0.7%, | | | | | | | | | | |
| dry) | | | | | | | | | | |
| Calcium | | | | | 5 | | | | | |
| carbonate 2 | | | | | | | | | | |
| CC2ASA | | | | | | 5 | | | | |
| (0.7%, dry) | | | | | | | | | | |
| CC2PPA | | | | | | | 5 | | | |
| (0.1%, dry) | | | | | | | | | | |
| CC2PPA | | | | | | | | 5 | | |
| (1%, dry) | | | | | | | | | | |
| CC3ASA | | | | | | | | | 5 | 10 |
| (0.7%, dry) | | | | | | | | | | |
| PlusTalc H05 | | | | | | | | | | |
| PPA | | | | | | | | | | |

TABLE 2b
Formulations of PLA 6100D compounded
with extruder and injection molding

| | C10 | C11 | C12 | C13 | C14 | C15 | C16 |
|---|---|---|---|---|---|---|---|
| PLA 6100D | 80 | 80 | 80 | 80 | 80 | 80 | 80 |
| Calcium | 20 | | | | | | |
| carbonate 1 | | | | | | | |
| CC1PPA | | 20 | | | | | |
| (0.1%, dry) | | | | | | | |
| CC1PPAASA | | | 20 | | | | |
| (0.1%, 0.7%, | | | | | | | |
| dry) | | | | | | | |
| Calcium | | | | 20 | | | |
| carbonate 2 | | | | | | | |
| CC2ASA | | | | | 20 | | |
| (0.7%, dry) | | | | | | | |
| CC2PPA | | | | | | 20 | |
| (0.1%, dry) | | | | | | | |
| CC2PPA | | | | | | | 20 |
| (1%, dry) | | | | | | | |
| CC3ASA | | | | | | | |
| (0.7%, dry) | | | | | | | |
| PlusTalc H05 | | | | | | | |
| PPA | | | | | | | |

TABLE 2c
Formulations of PLA 6100D compounded
with extruder and injection molding

| | C17 | C18 | C19 | C20 | C21 |
|---|---|---|---|---|---|
| PLA 6100D | 95 | 80 | 99.995 | 99.95 | 99.8 |
| Calcium carbonate 1 | | | | | |
| CC1PPA (0.1%, dry) | | | | | |
| CC1PPAASA (0.1%, | | | | | |
| 0.7%, dry) | | | | | |
| Calcium carbonate 2 | | | | | |
| CC2ASA (0.7%, dry) | | | | | |
| CC2PPA (0.1%, dry) | | | | | |
| CC2PPA (1%, dry) | | | | | |
| CC3ASA (0.7%, dry) | | | | | |
| PlusTalc H05 | 5 | 20 | | | |
| PPA | | | 0.005 | 0.05 | 0.2 |

Another compounding was conducted with Lab type twin-screw extruder model ZE12 with L/D 25:1 and die 0.5 mm from Three-Tec. PLA L130 was first crushed to <1 mm particles with a Retsch SR300 rotor beater mil and dried 2 hours at 70° C. prior to compounding. The PLA L130 and filer/additives are premixed and add into the hopper. Temperature profile of the barrel are:

$$T 1 = 170 ° C .$$

$$T 2 = 190 ° C .$$

$$T 3 = 190 ° C .$$

$$T 4 = 180 ° C .$$

After extrusion, the strand is pelletized and collected for further analysis such as thermal analysis or ashing or injection molding. The compositions are listed in Table 3 in wt %.

TABLE 3
Formulations of PLA L130 compounded with extruder and injection molding

| | C22 | C23 | C24 | C25 | C26 | C27 | C28 | C29 | C30 | C31 | C32 |
|---|---|---|---|---|---|---|---|---|---|---|---|
| PLA L130 | 100 | 95 | 95 | 95 | 95 | 95 | 95 | 95 | 95 | 95 | 95 |
| CC4PPA | | 5 | | | | | | | | | |
| (0.5%, dry) | | | | | | | | | | | |
| CC4PPAASA | | | 5 | | | | | | | | |
| (0.5%, 0.7% | | | | | | | | | | | |
| dry) | | | | | | | | | | | |
| CC4PPA | | | | 5 | | | | | | | |
| (0.1%, dry) | | | | | | | | | | | |
| CC5PPA | | | | | 5 | | | | | | |
| (0.5%, dry) | | | | | | | | | | | |
| CC5PPAASA | | | | | | 5 | | | | | |
| (0.5%, 0.7% | | | | | | | | | | | |
| dry) | | | | | | | | | | | |
| CC5PPA | | | | | | | 5 | | | | |
| (0.1%, dry) | | | | | | | | | | | |
| CC6PPA | | | | | | | | 5 | | | |
| (0.5%, dry) | | | | | | | | | | | |
| CC6PPAASA | | | | | | | | | 5 | | |
| (0.5%, 0.7% | | | | | | | | | | | |
| dry) | | | | | | | | | | | |
| CC6PPA | | | | | | | | | | 5 | |
| (0.1%, dry) | | | | | | | | | | | |
| PlusTalc H05 | | | | | | | | | | | 5 |

### 5. Properties

### a) Crystallization Behaviour

### L130 Compounds—First Series

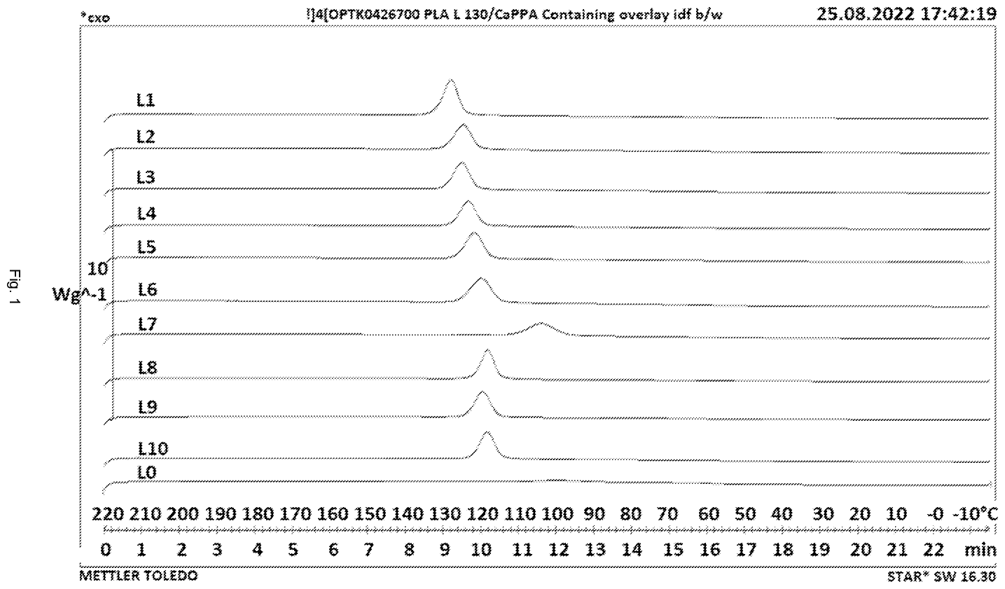

The DSC results of compounds with Rheomix are summarized in Table 4. The onset crystallization temperature of compounds with CaPPA and PPA treated calcium carbonate 1 are higher than those with Talc and untreated calcium carbonate 1. The peak crystallization temperature generally has the same trend as the onset crystallization temperature. The normalized enthalpy for the polymer is a measurement of PLA crystallinity and it is in line with the onset crystallization temperature. In other words, the more effective the nucleating effect, the higher the crystallinity. It is noted that talc (PlusTalc H05) is considered an effective nucleating agent for PLA and other semi-crystalline polymers. DSC thermograms are illustrated in FIG. 1 as reference.

TABLE 4
Crystallization characteristics of compounds by Rheomix,
measured with DSC method a), cooling rate at 10 K/min

| | | | Normalized | Normalized |
|---|---|---|---|---|
| Formulation | Onset | Peak | enthalpy | enthalpy |
| # | Tc (° C.) | Tc (° C.) | (J/g) | (J/g polymer) |
| L0 | — | — | — | — |
| L1 | 132.2 | 128.3 | 39.6 | 40.4 |
| L2 | 129.6 | 125.1 | 30.6 | 38.3 |
| L3 | 129.6 | 125.5 | 31.76 | 39.7 |
| L4 | 127.9 | 123.7 | 29.4 | 36.8 |
| L5 | 126.7 | 122.3 | 33.11 | 36.8 |
| L6 | 125.7 | 120.2 | 35.2 | 37.1 |
| L7 | 110.9 | 104.2 | 23.1 | 28.9 |
| L8 | 122.1 | 118.5 | 28.9 | 36.1 |
| L9 | 123.9 | 119.8 | 29.1 | 36.4 |
| L10 | 122.4 | 118.7 | 28.6 | 35.8 |

### PLA 6100D Compounds

The DSC results for the extruded compounds at different cooling rate are summarized in Table 5. The peak crystallization temperature and the enthalpy trend are the same for cooling rate at 10, 20 and 30 K/min and with PPA or CaPPA containing composition and Talc containing compositions have higher peak crystallization and enthalpy as well. At a cooling rate of 50 K/min, the trend of the peak crystallization temperature and enthalpy is not exactly the same as those at 10 K/min, but the compositions with Talc and PPA have a higher peak crystallization temperature and higher enthalpy. Overall the DSC results show the PPA treated calcium carbonate and PlusTalc H05 have an effective nucleating effect in PLA 6100D.

TABLE 5
DSC data - cooling at −10, 20, 30 and 50 K/min - PLA crystallization peak

| | Cooling rate (K/min) | | | | | | | |
|---|---|---|---|---|---|---|---|---|
| | 10 | | 20 | | 30 | | 50 | |
| | DSC method a) | | DSC method b) | | | | | |
| | | Integral | | Integral | | Integral | | Integral |
| | Peak | (J/g of | Peak | (J/g of | Peak | (J/g of | Peak | (J/g of |
| Sample | T° C. | PLA) | T° C. | PLA) | T° C. | PLA) | T° C. | PLA) |
| C0 | 97.91 | 23.46 | — | — | — | — | — | — |
| C1 | 98.90 | 21.88 | — | — | — | — | 98.52* | 3.50 |
| C2 | 118.02 | 42.58 | 104.64 | 30.59 | 98.30 | 19.50 | 98.63 | 3.08 |
| C3 | 116.26 | 39.81 | 105.11 | 31.53 | 98.32 | 19.65 | 98.58 | 4.22 |
| C4 | 102.45 | 30.76 | — | — | — | — | — | — |
| C5 | 100.57 | 21.45 | 100.86 | 26.31 | — | — | — | — |
| C6 | 114.03 | 40.62 | 102.86 | 30.52 | 96.76 | 10.97 | 96.89 | 2.59 |
| C7 | 120.09 | 44.00 | 106.96 | 41.72 | 101.41 | 29.68 | 99.47 | 7.54 |
| C8 | 104.84 | 36.77 | 95.12 | 4.33 | — | — | 97.92* | 0.98 |
| C9 | 102.47 | 34.97 | 93.42 | 3.80 | — | — | — | — |
| C10 | 109.93 | 38.46 | 97.84 | 22.69 | 94.23 | 5.39 | 98.56 | 5.82 |
| C11 | 119.23 | 42.74 | 107.88 | 32.43 | 102.39 | 29.70 | 99.41 | 7.46 |
| C12 | 119.48 | 45.18 | 107.61 | 32.69 | 101.42 | 31.00 | 97.83 | 5.86 |
| C13 | 103.26 | 38.42 | 98.09 | 11.47 | — | — | — | — |
| C14 | 100.91 | 25.28 | 95.40 | 3.57 | — | — | 102.69* | 2.92 |
| C15 | 117.69 | 42.54 | 105.92 | 24.98 | 100.29 | 23.51 | 99.45 | 3.05 |
| C16 | 123.59 | 42.00 | 113.35 | 33.30 | 105.90 | 33.23 | 101.29 | 14.40 |
| C17 | 116.26 | 43.35 | 106.11 | 30.29 | 100.97 | 33.12 | 102.03 | 11.50 |
| C18 | 118.57 | 43.01 | 110.94 | 32.46 | 106.48 | 29.13 | 106.27 | 22.88 |

*particularly difficult estimation - weak peak

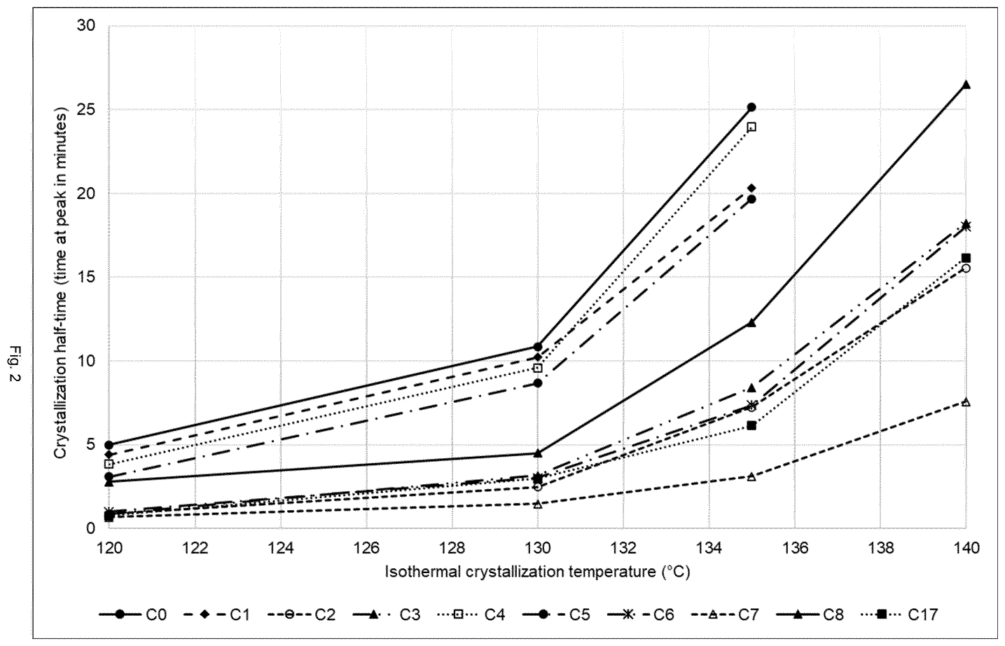

The isothermal crystallization data are summarized in Table 6 for 5 wt % and 20 wt % and plotted in FIG. 2 for 5 wt % nucleating agent samples, respectively. Overall, with higher PPA treated calcium carbonate, the half-time profile is the shortest and can even be lower than with Talc. With PPA coated calcium carbonate, the half-time is significantly shorter than with calcium carbonate without PPA treatment.

TABLE 6
Crystallization half-time measured with
DSC method c) of extruded compounds

| | | Crystallization half-time (min) for | | | |
|---|---|---|---|---|---|
| | | isothermal program at: | | | |
| | | 120° C. | 130° C. | 135° C. | 140° C. |
| C0 | PLA 6100D | 5 | 10.85 | 25.15 | >60 |
| C1 | 5% Calcium carbonate 1 | 4.4 | 10.23 | 20.33 | >60 |
| C2 | 5% CC1PPA (0.1%, dry) | 0.85 | 2.47 | 7.23 | 15.55 |
| C3 | 5% CC1PPAASA (0.1%, | 0.85 | 3.15 | 8.42 | 18.23 |
| | 0.7%, dry) | | | | |
| C4 | 5% Calcium carbonate 2 | 3.85 | 9.58 | 23.97 | >60 |
| C5 | 5% CC2ASA (0.7%, dry) | 3.1 | 8.67 | 19.67 | >60 |
| C6 | 5% CC2PPA (0.1%, dry) | 1 | 3.03 | 7.35 | 18 |
| C7 | 5% CC2PPA (1%, dry) | 0.68 | 1.48 | 3.12 | 7.58 |
| C8 | 5% CC3ASA (0.7%, dry) | 2.78 | 4.5 | 12.3 | 26.5 |
| C9 | 10% CC3ASA (0.7%, dry) | 2.87 | 8.98 | 17.23 | >60 |
| C10 | 20% Calcium carbonate 1 | 1.25 | 6.95 | 15.5 | >60 |
| C11 | 20% CC1PPA (0.1%, dry) | 0.65 | 1.7 | 4.7 | 10.98 |
| C12 | 20% CC1PPAASA (0.1%, | 0.6 | 2.38 | 6.1 | 11.98 |
| | 0.7%, dry) | | | | |
| C13 | 20% Calcium carbonate 2 | 1.13 | 6.67 | 21.9 | >60 |
| C14 | 20% CC2ASA (0.7%, dry) | 2.42 | 9.85 | 23.83 | >60 |
| C15 | 20% CC2PPA (0.1%, dry) | 0.8 | 1.88 | 4.55 | 12.52 |
| C16 | 20% CC2PPA (1%, dry) | 0.48 | 1.05 | 1.9 | 4.68 |
| C17 | 5% PlusTalc H05 | 0.77 | 2.97 | 6.13 | 16.15 |
| C18 | 20% PlusTalc H05 | 0.57 | 2.18 | 4.45 | 11.25 |
| C19 | 0.005% PPA as additive | 3.96 | 8.31 | 15.54 | 44.81 |
| C20 | 0.05% PPA as additive | 2.84 | 6.68 | 13.47 | 23.83 |
| C21 | 0.2% PPA as additive | 1.99 | 4.02 | 7.47 | 13.04 |

It can be seen that PPA and CaPPA surface treated calcium carbonate can provide significantly better results than calcium carbonate, ASA treated calcium carbonate or PPA alone, and even similar or better results than samples using Talc.

### L130 Compounds—Second Series

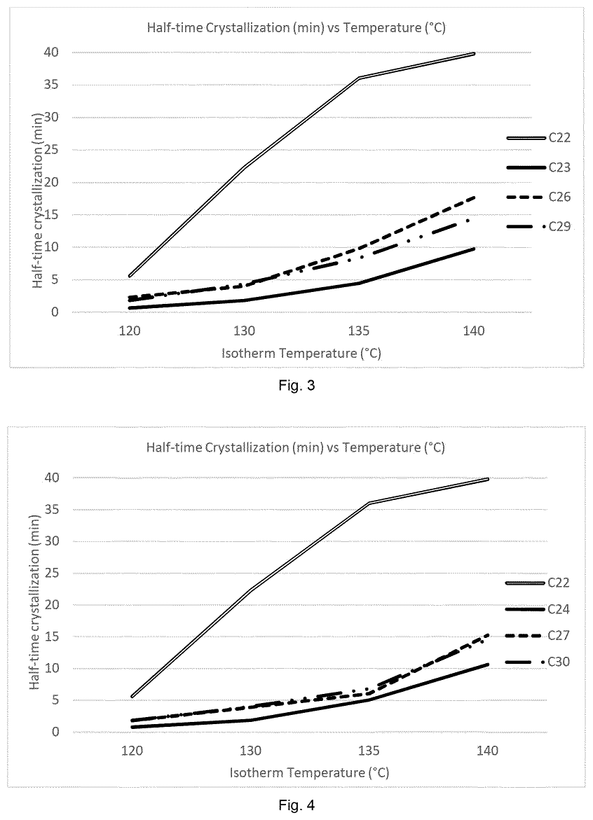

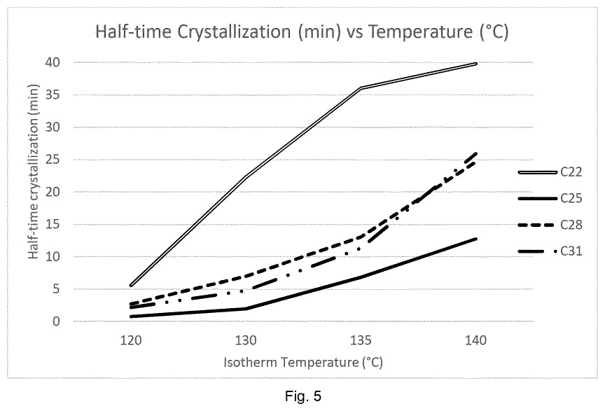

The DSC results of the extruded compounds are summarized in Table 7 and plotted in FIGS. 3 to 5. It can be gathered that the crystallization rate of compounds comprising PPA treated calcium carbonate 4 are faster than those comprising calcium carbonate 5 or calcium carbonate 6. The crystallization rate of calcium carbonate 4 is in the same order of magnitude than talc. In other words, the more effective the nucleating effect, the faster the crystallization process happens. It is noted that talc (such as PlusTalc H05) is considered an effective nucleating agent for PLA and other semi-crystalline polymers. This shows that ground calcium carbonate are more efficient than a precipitated calcium carbonate or a calcium carbonate based on eggshells.

TABLE 7
Half-time crystallization (min) of extruded compounds
measured with DSC method c), cooling rate at 10 K/min

| | | 120° C. | 130° C. | 135° C. | 140° C. |
|---|---|---|---|---|---|
| C22 | PLA L130 | 5.57 | 22.30 | 36.03 | 39.78 |
| C23 | CC4PPA (0.5%, dry) | 0.65 | 1.83 | 4.47 | 9.75 |
| C24 | CC4PPAASA (0.5%, | 0.77 | 1.83 | 5.03 | 10.63 |
| | 0.7% dry) | | | | |
| C25 | CC4PPA (0.1%, dry) | 0.78 | 1.95 | 6.82 | 12.75 |
| C26 | CC5PPA (0.5%, dry) | 2.30 | 4.05 | 9.78 | 17.63 |
| C27 | CC5PPAASA (0.5%, | 1.78 | 3.88 | 6.03 | 15.23 |
| | 0.7% dry) | | | | |
| C28 | CC5PPA (0.1%, dry) | 2.72 | 6.97 | 13.03 | 24.63 |
| C29 | CC6PPA (0.5%, dry) | 1.82 | 4.35 | 8.35 | 14.42 |
| C30 | CC6PPAASA (0.5%, | 1.82 | 3.98 | 6.82 | 14.57 |
| | 0.7% dry) | | | | |
| C31 | CC6PPA (0.1%, dry) | 2.18 | 4.77 | 11.30 | 25.90 |
| C32 | PlusTalc H05 | 0.57 | 2.23 | 4.35 | 11.58 |

It can be seen that PPA surface treated ground calcium carbonate can provide significantly better results than PPA surface treated precipitated calcium carbonate or PPA surface treated eggshells. This result is observed at different coating levels or in presence of ASA as well.

1.-20. (canceled)

21. A composition comprising calcium carbonate surface treated with phenylphosphonic acid and/or one or more salt(s) thereof,
wherein the calcium carbonate is a ground natural calcium carbonate (GNCC), and
wherein the ground natural calcium carbonate (GNCC) is at least partially coated with the phenylphosphonic acid and/or one or more salt(s) thereof.

22. The composition according to claim 21, wherein the ground natural calcium carbonate (GNCC) is selected from the group consisting of marble, chalk, limestone, dolomite, and mixtures thereof.

23. The composition according to claim 21, wherein the ground natural calcium carbonate (GNCC) has
a weight median particle diameter d₅₀ (wt) of from 0.2 to 20 μm, and/or
a top cut particle diameter d₉₈ (wt) of not more than 80 μm, and/or
a BET specific surface area of from 0.1 to 100 m²/g, and/or
a residual total moisture content of ≤0.5 wt %, based on the total dry weight of the natural ground calcium carbonate.

24. The composition according to claim 21, wherein the composition comprises the phenylphosphonic acid and/or one or more salt(s) thereof in an amount ranging from 0.001 to 5 wt %, based on the total weight of the ground natural calcium carbonate (GNCC) determined by TGA.

25. The composition according to claim 21, wherein the composition comprises the phenylphosphonic acid and/or one or more salt(s) thereof in an amount ranging from 0.005 to 20 mg/m², of the BET specific surface area of the ground natural calcium carbonate (GNCC).

26. The composition according to claim 21, wherein the composition comprising calcium carbonate surface treated with phenylphosphonic acid and/or one or more salt(s) thereof is surface treated with one or more additional treatment agent being selected from the group comprising
I) at least one mono-substituted succinic anhydride consisting of succinic anhydride mono-substituted with a group selected from a linear, branched, aliphatic and cyclic group having a total amount of carbon atoms from C2 to C30 in the substituent and/or salts thereof, and/or
II) at least one saturated or unsaturated aliphatic linear or branched carboxylic acid and/or salts thereof and/or reaction products thereof, and/or
III) a phosphoric acid ester blend of one or more phosphoric acid mono ester and/or salts thereof and/or one or more phosphoric acid di-ester and/or salts thereof, and/or
IV) at least one polydialkylsiloxane, and/or
V) at least one grafted polymer comprising at least one succinic anhydride group obtained by grafting maleic anhydride onto a homo- or copolymer comprising butadiene units and optionally styrene units and/or salts thereof, or
VI) mixtures of one or more materials according to I) to V).

27. The composition according to claim 21, wherein the composition comprises the additional treatment agent in an amount ranging from 0.001 to 3 wt %, based on the total weight of the ground natural calcium carbonate (GNCC), determined by TGA.

28. The composition according to claim 21, wherein the composition comprises the additional treatment agent in an amount ranging from 0.001 to 5 mg/m², of the BET specific surface area of the ground natural calcium carbonate (GNCC).

29. A process for manufacturing a composition comprising calcium carbonate surface treated with phenylphosphonic acid and/or one or more salt(s) according to claim 21, wherein the process comprises the steps of
a) providing ground natural calcium carbonate (GNCC) in dry form or in the form of an aqueous slurry,
b) providing phenylphosphonic acid and/or one or more salt(s) thereof, and
c) adding the phenylphosphonic acid and/or one or more salt(s) thereof of step b) to the ground natural calcium carbonate (GNCC) of step a),
wherein the process results in ground natural calcium carbonate (GNCC) which is at least partially coated with phenylphosphonic acid and/or one or more salt(s) thereof.

30. The process according to claim 29, wherein during and/or after step c), the process further comprises step d), wherein step d) is mixing the phenylphosphonic acid and/or one or more salt(s) thereof of step b) with the ground natural calcium carbonate (GNCC) of step a).

31. The process according to claim 29, wherein after step c) or after an optional mixing step d), the process further comprises a drying step e).

32. The process according to claim 29, wherein the phenylphosphonic acid or the salt of phenylphosphonic acid is added in an amount of from 0.005 to 20 mg/m², of the BET specific surface area of the ground natural calcium carbonate (GNCC).

33. The process according to claim 29, wherein the phenylphosphonic acid or the salt of phenylphosphonic acid is added in an amount of from 0.001 to 5 wt %, based on the weight of the ground natural calcium carbonate (GNCC).

34. A composition comprising ground natural calcium carbonate surface treated with phenylphosphonic acid and/or one or more salt(s) thereof, obtained by a process according to claim 29.

35. A nucleating agent comprising a composition comprising ground natural calcium carbonate surface treated with phenylphosphonic acid and/or one or more salt(s) thereof according to claim 21.

36. A polymer formulation comprising a composition comprising ground natural calcium carbonate surface treated with phenylphosphonic acid and/or one or more salt(s) thereof according to claim 21.

37. The polymer formulation according to claim 36, wherein the polymer formulation is selected from the group consisting of polylactic acid (PLA) formulations, poly L-lactic acid (PLLA) formulations, poly D-lactic acid (PDLA) formulations, poly DL-lactic acid (PDLLA) formulations, polyhydroxyalkanoate (PHA) formulations, polyhydroxybutyrate (PHB) formulations, polybutylenadipat-terephthalat (PBAT) formulations, polybutylene succinate (PBS) formulations, and mixtures thereof.

38. The polymer formulation according to claim 36, wherein the polymer formulation comprises the composition comprising ground natural calcium carbonate surface treated with phenylphosphonic acid and/or one or more salt(s) thereof in an amount of from 0.01 to 70 wt %, relating to the amount of polymer.

39. A method for producing a polymer formulation comprising a composition comprising ground natural calcium carbonate surface treated with phenylphosphonic acid and/or one or more salt(s) thereof according to claim 36, wherein the method comprises the steps of
a) providing a polymer;
b) providing the composition comprising ground natural calcium carbonate surface treated with phenylphosphonic acid and/or one or more salt(s) thereof;
c) contacting the polymer of step a) with the composition of step b); and
d) blending the contacted components of step c).

40. An article comprising the polymer formulation according to claim 36, wherein the article is selected from the group consisting of cups, straws, cutlery, plates, bottles, and automotive pieces.
